(19) United States
(12) Patent Application Publication
(10) Pub. No.: US 2005/0151351 A1
(43) Pub. Date: Jul. 14, 2005

(54) Fabric knee airbag for high internal pressures

(76) Inventors: Mark L. Enders, Pleasant View, UT (US); Louis A. Mueller, Roy, UT (US)

Correspondence Address: Sally J. Brown;AUTOLIV ASP, INC., 3350 Airport Road, Ogden, UT, 84405, US

(21) Appl. No.: 10/755,660

(22) Filed: Jan. 12, 2004

(51) Int. Cl. B60R 21/22

(52) U.S. Cl. 280/730.1

(57) ABSTRACT

A fabric knee airbag that is capable of withstanding high internal pressures is provided. The knee airbag is formed from one continuous fabric sheet. The knee airbag has a plurality of loops formed in the walls of the airbag. Internal tethers are disposed within the airbag cushion and are attached to oppositely facing loops. The internal tethers enable the airbag to withstand the high internal pressure by maintaining the airbag at a constant volume and shape upon activation by an inflator. The knee airbag further includes an external tether attached to the exterior of the airbag wall to control the direction of the deployment of the knee airbag.

### BACKGROUND OF THE INVENTION

1. Field of the Invention

The present invention relates to inflatable airbag systems for deployment in front of the knee area of an occupant. More specifically, the present invention relates to fabric knee airbag systems that include internal tether attachments to withstand high internal pressures.

2. Description of Related Art

Inflatable safety restraint devices, or airbags, are well accepted for use in motor vehicles and have been credited with preventing numerous deaths and injuries. Inflatable airbags are now mandatory on most new vehicles. Airbags are typically installed as part of a system with an airbag module in the steering wheel on the driver's side of a car and in the dashboard on the passenger side of a car. In the event of an accident, a sensor within the vehicle measures abnormal deceleration and triggers the ignition of a charge contained within an inflator. Expanding gases from the charge fill the airbags, which immediately inflate in front of the driver and passenger to protect them from harmful impact with the interior of the car.

During a front end collision, there is a tendency for an occupant, particularly one who is not properly restrained by a seat belt, to slide forward along the seat and “submarine” under the airbag (hereinafter referred to as the “primary airbag”). When the occupant submarines, the primary airbag is less effective in protecting the occupant. Such submarining causes the vehicle occupant's knees to contact the instrument panel or structure beneath the panel. Further injuries can occur when the occupant's legs move forward such that the knees are trapped in or beneath the instrument panel just before the foot well collapses. As the foot well collapses, the vehicle occupant's feet are pushed backward, which causes the knees to elevate and become further trapped. As the foot well continues to crush, the load on the trapped legs increase and can cause foot, ankle, and tibia injuries.

In order to prevent such injuries, inflatable knee airbag systems have been developed to engage an occupant's knees or lower legs and prevent submarining under the primary airbag. Knee airbag systems are generally positioned in the lower portion of the instrument panel. Typical knee airbag systems include a knee airbag, housing, and inflator. The inflator, once triggered, uses compressed gas, solid fuel, or their combination to produce rapidly expanding gas to inflate the airbag. The inflated knee airbag occupies a generally rectangular volume of the vehicle leg compartment.

Usually, knee airbag systems also include a fixed panel, called a load distribution panel or knee bolster panel. The load distribution panel is generally made of foam and hard plastic surrounding a metal substrate. A load distribution panel is used to distribute the load caused by the impinging legs and knees of an occupant over a larger area. Conventional fabric cushions are not normally used in knee airbag applications, without the aid of a load distribution panel because it is difficult to restrain an occupant's lower legs with a conventional fabric airbag. An occupant's legs have a very small contact area, and therefore exhibit a high force over a small area when in contact with the cushion. The lower legs tend to “knife” through the airbag because conventional fabric airbags do not have sufficient internal pressures to withstand such force. Conventional airbag cushions, such as those used for driver, passenger, or side applications, typically use bag pressures in the range of 4 to 6 pounds per square inch, which is an insufficient pressure to prevent an occupant's knees from knifing through the airbag.

However, load distribution panel designs have several limitations. One such limitation is that load distribution panel designs often involve complicated systems for attaching the load distribution panel to the airbag, thereby requiring more parts and skill in assembly than non-load distribution panel designs. The attached load distribution panel also limits the flexibility vehicle manufacturers have in designing the instrument panel because the knee airbag system has a surface area at least the size of the load distribution panel.

Accordingly, a need exists for a knee airbag system that can withstand the force of an occupant's lower legs to prevent “knifing” through the airbag. A soft surface knee airbag system is also desirable in order to minimize occupant injury. Furthermore, a need exists for an effective knee airbag module with a small surface area to give vehicle manufacturers more flexibility in designing the instrument panel. Such a device is disclosed and claimed herein.

### SUMMARY OF THE INVENTION

The apparatus of the present invention has been developed in response to the present state of the art, and in particular, in response to the problems and needs in the art that have not yet been fully solved by currently available knee airbag systems. Thus, the present invention provides an effective knee airbag constructed of fabric that can engage the knees and lower legs of a vehicle occupant when activated in a collision. A fabric knee airbag provides a less-rigid surface for impact protection than that provided by currently available load distribution panels. A fabric cushion in knee airbag applications is desirable to provide a soft impact surface so an occupant's knees and lower legs are not injured by the activated airbag.

In order to withstand the impinging force of an occupant's knees against the inflatable fabric cushion and prevent knifing through the airbag chamber, the airbag is inflated to a high internal pressure. That internal pressure could range from about 6 pounds per square inch to about 14 pounds per square inch, preferably in the range of about 10 to 14 pounds per square inch. The internal pressure achieved in the present invention is two to three times the pressure normally applied in conventional fabric airbag systems. The internal pressure is achieved by activating an inflator that is disposed partially or completely within the walls of the inflatable cushion.

According to one embodiment, internal tethers provide the support necessary for the airbag to withstand such high pressures. The internal tether could be a short piece of fabric that has a width smaller than the depth of the airbag cushion. The internal tether performs a shape-holding, volume-limiting function that prevents the fabric airbag cushion from assuming a spherical shape. In certain embodiments, the internal tethers maintain the volume of the knee airbag between about 16 liters and about 20 liters. The internal tethers may be positioned in such a manner that the top end of the airbag expands to a larger volume than the bottom end, so that the airbag contacts the occupant's knees instead of the occupant's tibia. In one embodiment, the fabric knee airbag located on a driver's side may contain two internal tethers.

The fabric knee airbag of the present invention also provides a novel method of attachment for internal tethers that has superior strength over internal tether attachments in the prior art. The novel tether attachments are created by forming a number of loops in the fabric of the inflatable cushion such that the loops extend across the width of the airbag cushion. Each loop has a companion loop facing it on the opposite side of the airbag cushion wall.

For example, if one loop is formed in the front face of the fabric knee airbag, then one loop is also formed in the back side of the fabric knee airbag, opposite the loop on the front face. Interconnecting each pair of oppositely facing loops is the internal tether. Since each internal tether corresponds to a pair of oppositely facing loops, four loops would be formed in the inflatable cushion wall to provide attachment locations for two internal tethers in driver's side applications. However, two internal tethers could be attached to one loop on the back side and two loops on the front side.

The loops that are formed in the airbag wall extend toward the interior of the airbag. When viewing the exterior of the inflated airbag, horizontally-running depressions are observable where the loops extend toward the interior of the airbag. The internal tethers are then attached to the side of each oppositely facing internal loop through stitching. The internal tethers could be attached through alternative means, such as bonding, welding, stapling, and the like. The geometry of this loop-in attachment joint reduces the shear load to the tether stitching thread compared to the butt joints employed in the prior art.

Alternatively, the loops may be formed in the airbag wall to extend outward, toward the exterior of the airbag. When viewing the exterior of the inflated airbag, horizontally-running loops are observable where depressions would be located on the embodiment utilizing loop-in joints. The internal tether is then attached to the interior of the loop, such that the loop surrounds the internal tether. The internal tether would also be attached by stitching or alternative means as discussed above. The geometry of this loop-out attachment joint also provides superior strength and a reduction in the shear load to the tether stitching thread compared to the butt joints in the prior art.

According to another alternative, the fabric knee airbag may comprise three internal tethers instead of two for passenger side airbag applications. Passenger side knee airbags may have an additional tether because the airbag usually has a height greater than that of the driver's side knee airbag. Passenger side knee airbags usually have a greater height than their driver's side counterparts because the passenger side knee airbag is typically located under the glove box or low on the instrument panel, which is lower than the location of the driver's side knee airbag on the instrument panel. A greater height ensures that the proper impact protection for a passenger's legs and knees is achieved.

In order for three internal tethers to be used in passenger knee airbag applications, six loops are formed in the walls of the knee airbag. Three loops may be formed in the front face of the airbag, and three opposing loops may be formed on the back side of the airbag, wherein each internal tether interconnects each opposing pair of loops. As mentioned above, the internal tethers can connect via a loop-in joint or a loop-out joint. Both types of attachment joints have superior strength than those found in the prior art.

The fabric knee airbag of the present invention also has an external tether located on the exterior of the knee airbag on its back side toward the top. The external tether may be attached to the fabric wall by stitching or alternative means as with the internal tether attachments. The external tether may be attached on either side of the loops formed on the backside of the airbag.

The external tether has a length shorter than the length of the airbag wall between attachment locations to the external tether. A wrinkle in the airbag wall is thereby present between the attachment locations of the external tether when the external tether is pulled tight during inflation of the knee airbag. Since the external tether has a length shorter than the length of the airbag wall between the external tether attachment locations, the external tether directs the airbag in an upward direction during inflation and deployment toward an occupant's knees and away from an occupant's tibia.

The fabric knee airbag may also be formed from one continuous fabric sheet that is folded over and sealed on its sides through stitching, or alternatively, welding, bonding, or the like. The continuous fabric configuration provides for excellent hoop strength upon inflation compared to multi-paneled airbags.

These and other features and advantages of the present invention will become more fully apparent from the following description and appended claims, or may be learned by the practice of the invention as set forth hereinafter.

### BRIEF DESCRIPTION OF THE DRAWINGS

In order that the manner in which the above-recited and other features and advantages of the invention are obtained will be readily understood, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 is a perspective view of inflated knee airbags located on both the driver's side and the passenger side of an interior of a vehicle;

FIG. 2A is a side cross-sectional view of a driver's side knee airbag of the present invention during initial deployment;

FIG. 2B is a side cross-sectional view of a driver's side knee airbag of the present invention after full deployment;

FIG. 3 is a front plan view of the inflated driver's side knee airbag of FIG. 2B;

FIG. 4 is a partially cut-away perspective view of the inflated driver's side knee airbag of FIG. 2B;

FIG. 5 is a side elevation sectional view of prior art internal airbag tethers fastened to the side walls of an airbag cushion;

FIG. 6A is a side cross-sectional view of loop-in internal tether attachment joints formed in the side walls of a driver's side knee airbag cushion;

FIG. 6B is a side cross-sectional view of loop-in internal tether attachment joints formed in the side walls of a passenger side knee airbag cushion;

FIG. 7 is a side cross-sectional view of loop-out internal tether attachment joints formed in the side walls of a driver's side knee airbag cushion;

FIG. 8A is a side view of the fabric for a driver's side knee airbag before assembly with loop-in joints formed in the fabric; and

FIG. 8B is a top plan view of the fabric for a driver's side knee airbag before assembly with loop-in joints formed in the fabric.

### DETAILED DESCRIPTION OF THE PREFERRED EMBODIMENTS

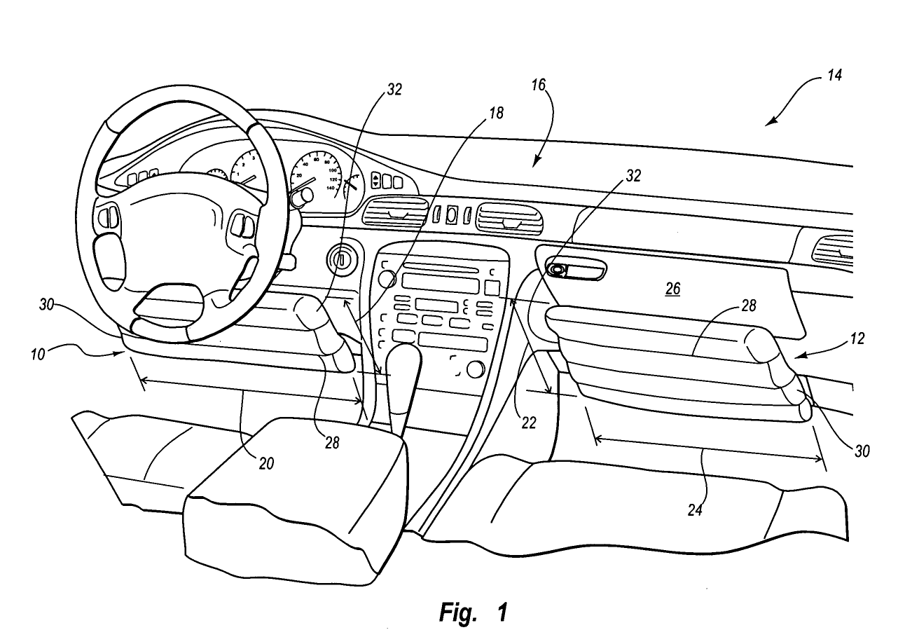

The presently preferred embodiments of the present invention will be best understood by reference to the drawings, wherein like parts are designated by like numerals throughout. It will be readily understood that the components of the present invention, as generally described and illustrated in the figures herein, could be arranged and designed in a wide variety of different configurations. Thus, the following more detailed description of the embodiments of the apparatus, system, and method of the present invention, as represented in FIGS. 1 through 8B, is not intended to limit the scope of the invention, as claimed, but is merely representative of presently preferred embodiments of the invention.

Referring to FIG. 1, a driver's side knee airbag 10 and a passenger side knee airbag 12 are depicted in an inflated state within a vehicle 14. The knee airbags 10, 12 are constructed of fabric to provide a soft impact surface for the lower extremities of an occupant. The knee airbags 10, 12 deploy in an area that is likely to be engaged by an occupant's lower legs and knees in a collision. This area is the impact protection zone.

To deploy in the impact protection zone, the knee airbags 10, 12 are located proximate the bottom portion of the vehicle instrument panel 16. The knee airbag system could be located on just the driver's side to protect a driver, on the passenger side to protect a passenger, or on both sides as depicted in FIG. 1. The shape of the knee airbags 10, 12 is substantially rectangular, but could be elliptical, circular, or another configuration. All that is required is adequate impact protection coverage for the knees and legs of vehicle occupants.

In order to provide sufficient impact protection coverage for different occupant drivers that vary in their seating position and/or height, the driver's side knee airbag 10 will have a height 18 and a width 20 sufficiently sized to engage the lower extremities of an occupant in various positions as illustrate in FIG. 1. It has been found that a height 18 of about sixteen inches, and a width 20 of about twenty-one inches is adequate to provide the necessary impact protection coverage on the driver's side.

With regards to the passenger side, the height 22 of the passenger side knee airbag 12 may be greater than the height 18 of the driver's side knee airbag because the passenger side knee airbag 12 is typically located under the glove box 26, or low on the instrument panel 16. A greater height 22 ensures that the proper impact protection for a passenger's legs and knees is achieved. It has been found that a height 22 of about nineteen inches, and a width 24 of about twenty-one inches is adequate to provide the necessary impact protection coverage for an occupant in the passenger seat.

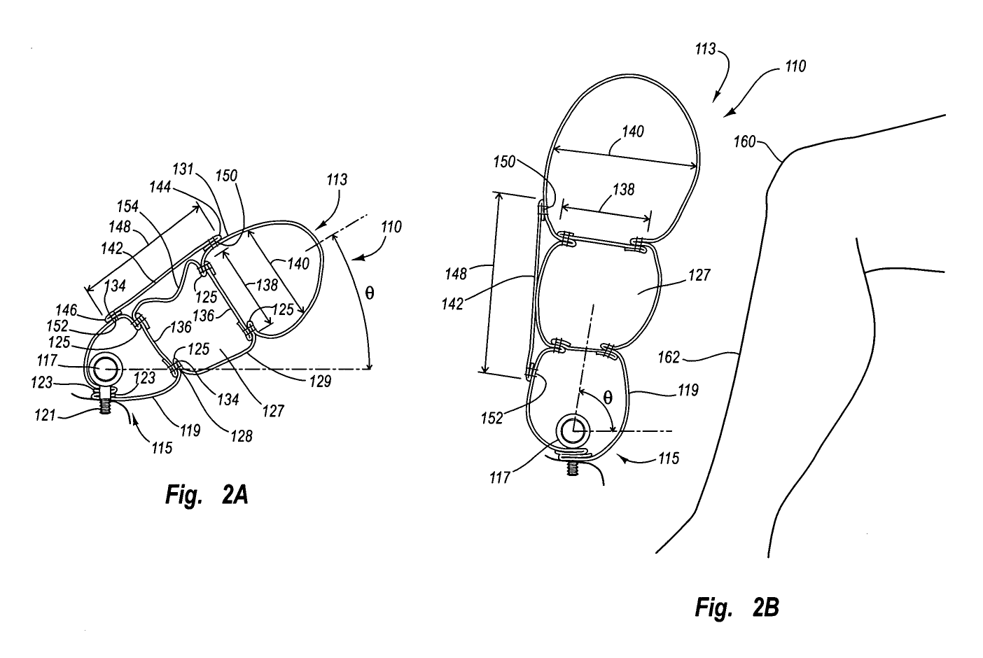

Referring still to FIG. 1, in order to withstand the impinging force of an occupant's knees against the knee airbag 10, 12 and prevent knifing through the airbag chamber, the knee airbag 10, 12 is inflated to a high internal pressure. Internal tethers provide the support necessary for the knee airbag 10, 12 to withstand the high pressure. The internal tethers serve a shape-holding, volume-limiting function. The internal pressures and the use of internal tethers will be discussed in greater detail in conjunction with FIGS. 2A and 2B. As shown in FIG. 1, the knee airbags 10, 12 may have one or more depressions 28 that run horizontally from the outboard side 30 to the inboard side 32 of the knee airbags 10, 12. Each depression 28 corresponds to an internal tether. The depressions 28 constitute the inner portions of internal loops in the wall of the airbag cushion. The function of the loops will be discussed in further detail in conjunction with FIGS. 2A through 8B.

Preferably, the driver's side knee airbag 10 has two internal tethers, and hence two depressions 28 are depicted. The passenger side knee airbag 12 may have three internal tethers with three corresponding lateral depressions 28. The additional internal tether is used on the passenger side knee airbag 12 to maintain a volume similar to the driver's side knee airbag 10, while having a height 22 larger than the height 18 of the driver's side knee airbag 10.

Referring to FIG. 2A, a side cross-sectional view of a driver's side knee airbag 110 is depicted during initial deployment, while the airbag 110 is inflating. The knee airbag 110 is constructed of a fabric material to provide a soft surface so an occupant's lower extremities, such as knees and lower legs, are not injured by the activated airbag 110. The knee airbag 110 has a top end 113 and a bottom end 115. The walls 119 of the knee airbag 110 are constructed from a continuous fabric sheet, folded together. The ends of the walls 119 (hereinafter “wall ends 123”) represent opposing outer edges of the continuous fabric sheet that are brought together, adjacent an inflator 117, to form the knee airbag 110.

The inflator 117 is disposed either partially or completely within the walls 119 of the knee airbag 110, proximate the bottom end 115. The inflator 117 could be a pyrotechnic that uses the combustion of gas-generating material to generate inflation fluid. Alternatively, the inflator 117 could contain a stored quantity of pressurized inflation fluid or a combination of pressurized inflation fluid and ignitable material for heating the inflation fluid. In order to prevent an occupant from knifing through the airbag chamber 127, the knee airbag 110 is inflated to a high internal pressure of at least six pounds per square inch. Preferably, the internal pressure necessary to prevent an occupant from knifing through the airbag 110 would be between about ten pounds per square inch and about fourteen pounds per square inch.

Protruding from the inflator 117 is a mounting stud 121, or a plurality of mounting studs. The mounting studs 121 project through the walls 119 of the knee airbag 110 to mount to a desired location proximate the instrument panel. The wall ends 123 of the knee airbag 110 may be folded over to reinforce the junction created by the intersection of the wall ends 123 and the inflator mounting studs 121. The wall ends 123 may also have orifices formed within the fabric wall 119 to receive the inflator mounting studs 121. When assembled, the inflator mounting studs 121 can cinch down upon the wall ends 123, sealing the opening that would otherwise exist between wall ends 123. This helps prevent inflation fluid from escaping rapidly upon activation of the inflator 117.

Internal tethers 136 are located inside the chamber 127 of the knee airbag 110 to provide the support necessary for the fabric knee airbag 110 to withstand high internal pressures. The internal tether 136 may be a piece of fabric having a width 138 smaller than a depth 140 of the knee airbag 110 from the front face 129 to the back side 131 of the airbag wall 119. Alternatively, the internal tether 136 may be a strap instead of a piece of fabric. The smaller width 138 of the internal tether 136 limits the natural tendency of the knee airbag 110 to assume a spherical shape upon inflation. The internal tether 136 thereby controls the volume of the chamber 127. There should be at least one internal tether 136 disposed within the chamber 127, but preferably two or more.

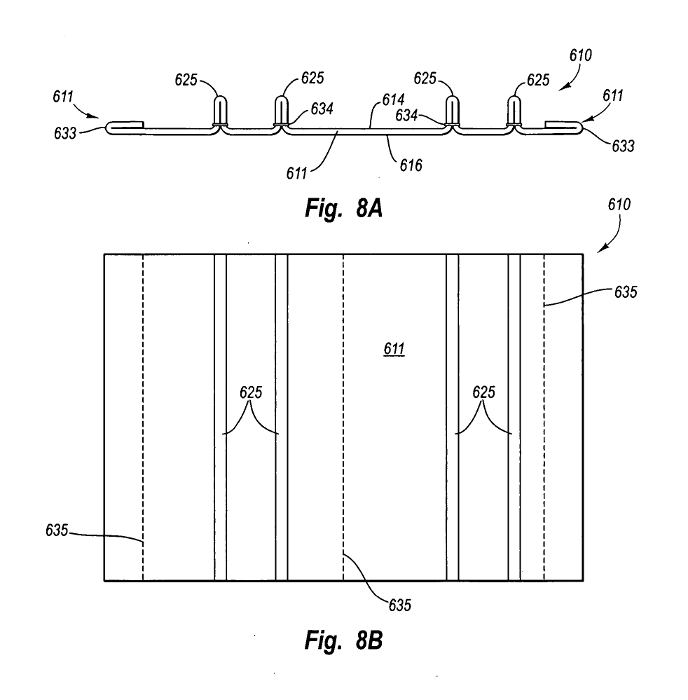

Referring still to FIG. 2A, the knee airbag 110 also provides a novel method of attachment for the internal tethers 136 to the airbag wall 119 that provides sufficient strength to withstand the high internal pressures. The novel tether 136 attachments are created by forming a plurality of loops 125 within the walls of the knee airbag 110 by folding together a small section of the airbag wall 119 fabric (See FIG. 8A). These loops 125 could be formed either inside the airbag chamber 127 or outside the chamber.

As depicted in FIG. 2A, four loops 125 are formed inside the chamber 127. Two loops 125 are formed on the front face 129 of the knee airbag 110, and two corresponding loops 125 are formed on the back side 131 of the knee airbag 110. The loops 125 are maintained in the airbag wall 119 through stitching 134. However, alternative means such as tacking, stapling, welding, or bonding may be employed to maintain the loops 125 in the walls 119 of the knee airbag 110. Each loop 125 creates a depression 128 on the outside of the airbag walls 119, and corresponds with the laterally extending depressions 28 depicted in FIG. 1.

Each pair of oppositely facing loops 125 has an internal tether 136 fastened to the side of each loop 125 through stitching 134. As with the creation of the loops 125, the internal tethers 136 may also be fastened to the side of each loop 125 by bonding, welding, tacking, stapling, and the like. The geometry of the internal tether 136 attachment to the loops 125 reduces the shear load to the tether stitching thread 134 compared to attachments employed in the prior art.

Referring still to FIG. 2A, an external tether 142 is located on the back side 131 of the knee airbag 110, toward the knee airbag's top end 113. The external tether 142 is fastened to the outside wall 119 of the airbag 110 through stitching 134. The external tether 142 could also be affixed to the airbag wall 119 by means of bonding, welding, tacking, stapling, and the like. The external tether 142 has a top edge 144 that may be attached to the airbag wall 119 at the top attachment location 150. The top attachment location 150 is on the back side 131 of the airbag 110, above the loops 125 in the airbag wall 119. The bottom attachment location 152 is on the back side 131 of the airbag 110, below the loops 125 in the airbag wall 119.

The length 148 of the external tether 142 is shorter than the length of the airbag wall 119 between the top attachment location 150 and the bottom attachment location 152. A wrinkle 154 is thereby present between attachment locations 150, 152 in the back side 131 wall 119 of the knee airbag 110 when the external tether 142 is pulled tight during inflation.

Referring now to FIG. 2B, a side cross-sectional view of the driver's side knee airbag 110 is depicted after full deployment. The external tether 142 helps to direct the knee airbag 110 in an upward direction during deployment toward an occupant's knees 160. This function of the external tether 142 is achieved because the external tether 142 has a length 148 smaller than the length of the airbag wall 119 between attachment locations 150, 152.

As most knee airbag 110 modules are typically located low on the instrument panel of a vehicle, the airbag 110 would impact an occupant's lower legs or tibia 162 if it deployed directly outward from its mounting location. This could result in injuries to the occupant's tibia 162. The external tether 142 directs the deployment of the airbag 110 upward toward the occupant's knees 160 and not the occupant's tibia 162 while the airbag 110 is inflating to prevent such injuries. Furthermore, the top end 113 of the knee airbag 110 expands to a larger volume than the bottom end 115 so the airbag 110 contacts the occupant's knees 160 instead of the occupant's tibia 162.

Referring still to FIG. 2B, the knee airbag 110 is constructed of a fabric material. Typical fabric airbags used in driver, passenger, and side applications are inflated to pressures between four pounds per square inch and six pounds per square inch. As mentioned earlier, to prevent the knifing of an occupant's knees and lower legs 160, 162 through the airbag chamber 127, the airbag 110 should be inflated to a high internal pressure of at least six pounds per square inch. Preferably, the internal pressure would be between about ten pounds per square inch and fourteen pounds per square inch. The fabric knee airbag 110, typically has a cushion volume between about sixteen liters and about twenty liters. The volume could vary depending upon the relative size of the impact protection areas required for a particular vehicle.

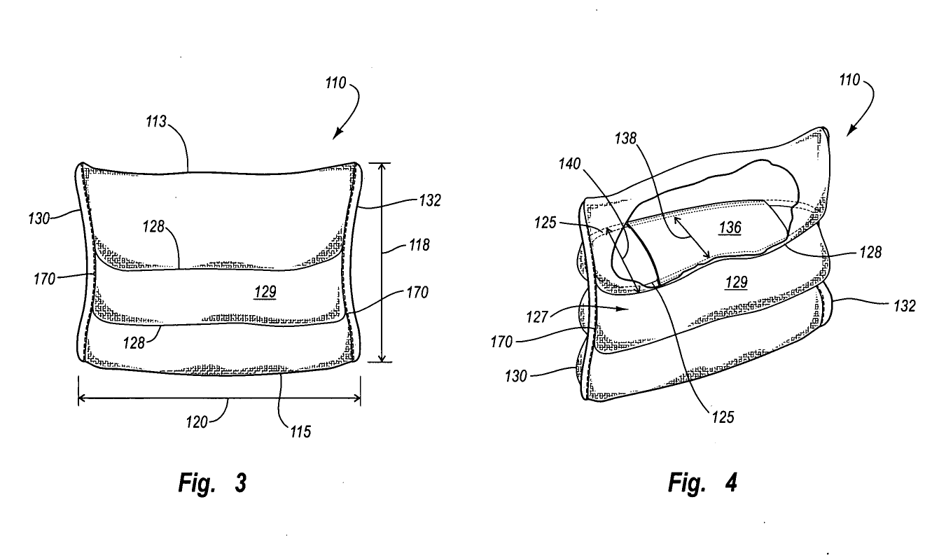

Referring to FIG. 3, the fully deployed and inflated driver's side knee airbag 110 of FIGS. 2A and 2B is shown. The knee airbag 110 is a sewn fabric cushion constructed of one continuous sheet of fabric with stitching 170 on the inboard 132 and outboard sides 130. As depicted, the knee airbag 110 is typically rectangular in shape with a height 118 of about sixteen inches and a width 120 of about twenty-one inches. Alternatively, the knee airbag 110 could be another shape to provide impact protection for an occupant's lower legs such as being square, elliptical, or circular. The top end 113 of the knee airbag 110 is more expanded than the bottom end 115 so the knee airbag 110 engages an occupant's knees instead of the occupant's fragile tibia.

As discussed in conjunction with FIGS. 2A and 2B, the driver's side knee airbag 110 of FIG. 3 has internal loops 125 formed in the fabric of the airbag 110. Two of the loops 125 are located on the interior portion of the front face 129 of the airbag and correspond to the two depressions 128 that extend from the inboard side 132 of the airbag 110 to the outboard side 131. Each depression 128 corresponds to an internal loop 125 which is attached to an internal tether that provides a shape-holding function to prevent the knee airbag 110 from expanding to a spherical shape.

Referring to FIG. 4, the inflated driver's side knee airbag 110 is depicted in a partially cut-away perspective view. An internal tether 136 that corresponds to the uppermost depression 128 is shown attached to a pair of internally projecting loops 125 in the fabric of the knee airbag 110. The internal tether 136 may be attached to the side of each inwardly-facing loop 125 through stitching. The internal tether 136 is a wide piece of fabric that has a width 138 shorter than the depth 140 of the knee airbag 110. Alternatively, the internal tether 136 could be a strap. The smaller width 138 of the internal tether 136 limits the natural tendency of the knee airbag 110 to assume a spherical shape upon inflation. The internal tether 136 thereby controls the volume of the chamber 127.

The location of the internal tether 136 inside the knee airbag 110 causes the outboard side 130 and the inboard side 132 to be more expanded than the center when the knee airbag 110 is inflated. The concave surface of the front face 129 of the knee airbag 110 helps to retain an occupant's knees in the center of the airbag 110 instead of forcing the occupant's legs apart when the airbag 110 deploys.

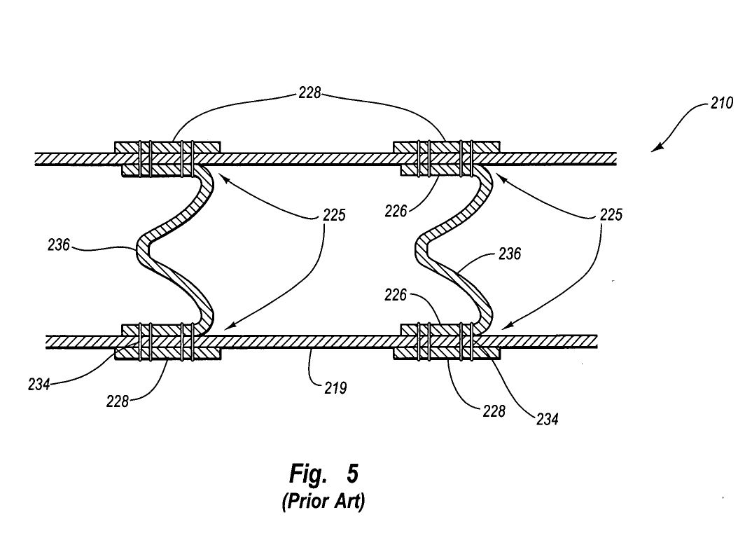

Referring to FIG. 5, prior art internal tether 236 attachments 225 to an airbag cushion 210 are depicted in a side cross-sectional view. The prior art internal tethers 236 are typically attached to the airbag walls 219 through a butt joint 226, where the end of each internal tether 236 is sewn to the exterior airbag walls 219 through stitching 234. A box-type stitch is usually employed. To reinforce the internal tether 236 attachments 225, localized additional fabric 228 is sewn opposite the internal tether 236 attachments 225 through the airbag walls 219. Such tether attachments 225 are labor intensive and are weaker than the tether attachments of the present invention.

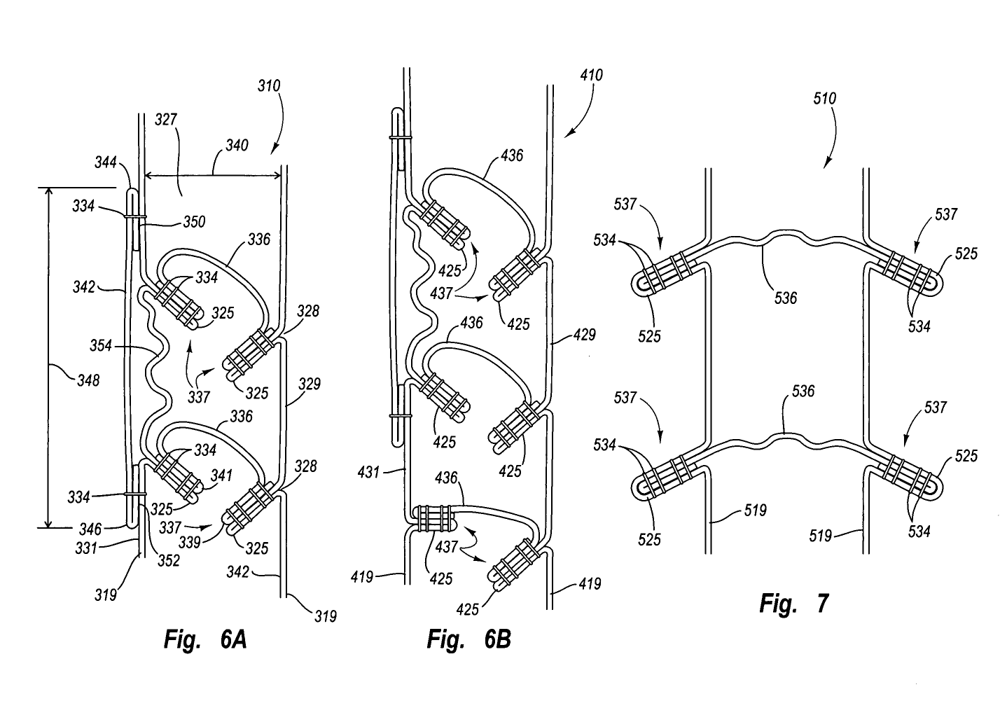

Referring now to FIG. 6A, loop-in attachment joints 337 for the internal tethers 325 of an uninflated driver's side knee airbag 310 are shown from a side cross-sectional view. The internal tether 336 may be a short piece of fabric that has a width shorter than the depth 340 of the knee airbag 310. The depth 340 of the airbag 310 is the distance from the front face 329 to the back side 331 of the airbag wall 319 when the airbag 310 is fully inflated (as shown in FIGS. 2B and 4). The shorter width of the internal tether 336 limits the natural tendency of the knee airbag 310 to assume a spherical shape upon inflation. The internal tether 336 thereby controls the volume of the airbag chamber 327. At least one internal tether 336 is located within the chamber 327. However, with driver's side knee airbag 310 applications there will preferably be two internal tethers 336.

The internal tethers 336 are attached to loops 325 formed in the walls 319 of the knee airbag 110. For the driver's side knee airbag 110, four loops 325 are formed in the airbag walls 319: two loops 325 on the front face 329 of the knee airbag 310 and two loops 325 on the back side 331. The attachment joints 337 are called “loop-in” joints because the loops 325 formed in the airbag walls 319 all extend toward the interior of the knee airbag 310. Consequently, the loop-in attachment joints 337 leave depressions 328 on the exterior of the wall 319 of the knee airbag 310.

The internal tethers 336 are attached to the side of each internal loop 325 through stitching 334. Alternatively, the internal tethers 336 could be attached through bonding, welding, stapling, and the like. One internal tether 336 is attached to a pair of opposing loops 325, such that the first end 339 of the internal tether 336 is attached to a loop 325 formed in the front face 329 of the airbag 310 and the second end 341 of the internal tether 336 is attached to an oppositely facing loop 325 formed in the back side 331 of the airbag 310. The geometry of the loop-in attachment joints 337 provide superior strength to typical prior art internal tether attachment joints by reducing the shear loads to the joint stitching thread 334.

Referring still to FIG. 6A, an external tether 342 for helping to direct the deployment of the knee airbag 310 is depicted. The external tether 342 is located on the outside of the knee airbag 310, on its back side 331. The external tether 342 is fastened to the outside wall 319 of the airbag 310 through stitching 334. A single stitch 334 is normally employed; however, alternatively, a pair of stitches or a dual pair of stitches could be used to attach the external tether 342 to the outside wall 319 of the airbag. The external tether 342 could also be affixed to the airbag wall 319 by means of bonding, welding, tacking, stapling, and the like.

The external tether 342 has a top edge 344 that may be attached to the airbag wall 319 at the top attachment location 350. The top attachment location 350 is above the loops 325 on the back side 331 of the airbag wall 319. The bottom edge 346 of the external tether 342 may be attached to the airbag wall 319 below the loops 325 on the back side 331 of the airbag 310. This is the bottom attachment location 352 of the external tether 342. The external tether 342 has a length 348 smaller than the length of the airbag wall 319 between the top attachment location 350 and the bottom attachment location 352. A wrinkle 354 is thereby present in the back side 331 wall 319 of the knee airbag 310 when the external tether 342 is pulled tight during inflation.

Referring to FIG. 6B, loop-in attachment joints 437 formed in the walls 419 of an uninflated passenger side knee airbag 410 are shown from a side cross-sectional view. For passenger side knee airbag 410 applications, typically three internal tethers 436 are used to provide appropriate shape and volume and to withstand high internal pressures. Passenger side knee airbags 410 may have an additional internal tether 436 compared to their driver's side counterparts, because the passenger side knee airbag 410 usually has a greater height than the driver's side knee airbag. Passenger side knee airbags 410 are typically located under the glove box or low on the instrument panel, lower than the location of the driver's side knee airbag. A greater height ensures that the proper impact protection for a passenger's legs and knees is achieved.

As with driver's side knee airbag applications, the internal tethers 436 are attached to loops 425 formed in the walls 419 of the knee airbag 410. For passenger side knee airbag 410 applications, six loops 425 are formed in the airbag walls 419: three loops 425 on the front face 429 of the knee airbag 410 and three loops 425 on the back side 431. The loops 425 extend toward the interior of the airbag 410. An internal tether 436 is then attached to the side of each pair of oppositely facing loops 425 to form the loop-in attachment joints 437.

Referring now to FIG. 7, loop-out attachment joints 537 formed in the walls 519 of an uninflated driver's side knee airbag 510 are shown from a side cross-sectional view. The attachment joints 537 are termed “loop-out” joints because the loops 525 formed in the airbag walls 519 all extend outward from the exterior of the knee airbag 510. The internal tethers 536 are then located inside each external loop 525 and attached to the inside of each loop 525 through stitching 534. Alternatively, the internal tethers 536 could be attached to the inside of each loop 525 through bonding, welding, stapling, and the like.

Like the loop-in attachment configuration of FIGS. 6A and 6B, each internal tether 536 interconnects a pair of opposing loops 525. Also, like the loop-in attachment joints, the geometry of the loop-out attachment joints 537 provide superior strength to typical prior art internal tether attachment joints by reducing the shear loads to the joint stitching thread 534.

Referring to FIG. 8A, the fabric sheet 611 for a driver's side knee airbag 610 is depicted from a side view before assembly. Four loops 625 are formed in the continuous fabric sheet 611, and may be maintained in position through stitching 634 or other means such as bonding, welding, stapling, and the like. Six loops 625 may be formed in the fabric sheet 611 if the assembly were for a passenger side knee airbag. The loops 625 are formed on what will become the interior side 614 of the knee airbag 610. These loops 625 will become the attachment locations for the internal tether forming the above mentioned loop-in joints (See FIGS. 6A and 6B). The loops 625 could be formed on what will become the exterior side 616 of the knee airbag 610 if loop-out joints are employed as the internal tether attachments. The ends of the fabric sheet 611 have folds 633 which will be located proximate an inflator for delivering inflation gases to the airbag 610.

FIG. 8B shows a top plan view of the continuous fabric sheet 611 that will form the driver's side knee airbag 610. The four internal loops 625 extend throughout the width of the fabric sheet 611. The loops 625 will become the loop-in attachment joints for two internal tethers once the fabric sheet 611 is folded and sewn to form the knee airbag 610. Fold lines 635 indicate where the fabric sheet 611 will be folded to form the knee airbag 610. The fabric sheet 611 will be folded in such a manner that the fold lines 635 and the loops 625 will be internal to the airbag 610.

Once folded, two internal tethers are attached to oppositely facing loops 625 forming loop-in joints as described in accordance with FIGS. 6A and 6B. The perimeter of the folded fabric sheet 611 is then sealed by stitching, bonding, welding, or the like to retain inflation gases when the knee airbag 610 must be inflated. An external tether is then attached on the back side of the exterior of the knee airbag 610 to control deployment of the knee airbag 610.

Forming the knee airbag 610 from one continuous fabric sheet 611 provides greater strength than by forming the knee airbag 610 from several separate panels. The continuous sheet 611 design provides excellent hoop strength which is needed in high internal pressure applications such as provided by the fabric knee airbag 610 of the present invention.

Accordingly, the fabric knee airbag of the present invention presents significant improvements in addressing the design limitations associated with rigid load distribution panel systems. The knee airbag of the present invention provides a soft contact surface through the use of a fabric construction. The present invention also prevents an occupant's knees and lower legs from knifing through the airbag by inflating the knee airbag to a high internal pressure. The fabric knee airbag is capable of withstanding such high pressures through the use of internal tethers that have superior strength attachment joints to the airbag wall compared to the prior art.

The knee airbag of the present invention also provides for excellent hoop strength through the use of one continuous fabric sheet in the airbag's formation. Furthermore, by not using a load distribution panel, the knee airbag of the present invention provides manufacturers more flexibility in designing the instrument panel because the large-area load distribution panel is absent and need not be designed around.

The present invention may be embodied in other specific forms without departing from its structures, methods, or other essential characteristics as broadly described herein and claimed hereinafter. The described embodiments are to be considered only as illustrative, and not restrictive. The scope of the invention is indicated by the appended claims, rather than by the foregoing description. All changes that come within the meaning and range of equivalency of the claims are to be embraced within their scope.

1. A knee airbag assembly, comprising:
an inflatable fabric cushion having a first side and a second side, the first and second sides being opposite each other;
a loop being formed in the fabric of the first side;
a loop being formed in the fabric of the second side; and
a first tether located on an internal side of the inflatable cushion, the first internal tether attached to and interconnecting the loop on the first side and the loop on the second side.

2. The airbag assembly of claim 1, wherein the inflatable cushion is formed from one continuous sheet of fabric material.

3. The airbag assembly of claim 1, further comprising a tether located on an external side of the inflatable cushion, the external tether being attached to the fabric of the second side of the inflatable cushion.

4. The airbag assembly of claim 3, wherein the external tether has a first end and a second end, both first and second ends attached to the second side of the inflatable cushion, such that a portion of the inflatable cushion is located between attachment locations of the first and second ends.

5. The airbag assembly of claim 4, wherein the external tether has a length shorter than a length of the portion of the inflatable cushion located between attachment locations of the first and second ends of the external tether.

6. The airbag assembly of claim 1, wherein each loop in the fabric of the inflatable cushion extends in a direction toward the inside of the inflatable cushion, such that each loop has at least two sides which extend in a direction substantially parallel to the direction each loop extends.

7. The airbag assembly of claim 6, wherein the first internal tether is attached to a side of the loop on the first side of the inflatable cushion, on the outside of the loop, and the first internal tether is attached to a side of the loop on the second side of the inflatable cushion, on the outside of the loop.

8. The airbag assembly of claim 1, wherein each loop in the fabric of the inflatable cushion extends in a direction toward the outside of the inflatable cushion, such that each loop has at least two sides which extend in a direction substantially parallel to the direction each loop extends.

9. The airbag assembly of claim 8, wherein the first internal tether is attached to the sides of the loop on the first side of the inflatable cushion, on the inside of the loop, and the first internal tether is attached to the sides of the loop on the second side of the inflatable cushion, on the inside of the loop.

10. The airbag assembly of claim 1, further comprising a second loop in the first side of the inflatable cushion and a second loop in the second side of the inflatable cushion, and a second tether located on an internal side of the inflatable cushion, the second internal tether attached to and interconnecting the second loop on the first side and the second loop on the second side.

11. The airbag assembly of claim 10, further comprising a third loop in the first side of the inflatable cushion and a third loop in the second side of the inflatable cushion, and a third tether located on an internal side of the inflatable cushion, the third internal tether attached to and interconnecting the third loop on the first side and the third loop on the second side.

12. The airbag assembly of claim 1, wherein the first internal tether has a width shorter than a distance that the first side of the inflatable cushion can be separated from the second side.

13. The airbag assembly of claim 1, further comprising an inflator for inflating the inflatable cushion.

14. The airbag assembly of claim 13, wherein the inflator inflates the inflatable cushion to an internal pressure between about 6 pounds per square inch and about 14 pounds per square inch.

15. The airbag assembly of claim 14, wherein the inflator inflates the inflatable cushion to an internal pressure between about 10 pounds per square inch and about 14 pounds per square inch.

16. A knee airbag assembly, comprising:
an inflatable fabric cushion having a first side and a second side, the first and second sides being opposite each other;
at least one loop being formed in the fabric of the first side;
at least one loop being formed in the fabric of the second side; and
two or more tethers located on an internal side of the inflatable cushion, each internal tether attached to and interconnecting a loop on the first side and a loop on the second side.

17. The airbag assembly of claim 16, further comprising a tether located on an external side of the inflatable cushion, the external tether being attached to the fabric of the second side of the inflatable cushion.

18. The airbag assembly of claim 17, wherein the external tether has a first end and a second end, both first and second ends attached to the second side of the inflatable cushion, such that a portion of the inflatable cushion is located between attachment locations of the first and second ends.

19. The airbag assembly of claim 18, wherein the external tether has a length shorter than a length of the portion of the inflatable cushion located between attachment locations of the first and second ends of the external tether.

20. The airbag assembly of claim 19, wherein each loop in the fabric of the inflatable cushion extends in a direction toward the inside of the inflatable cushion, such that each loop has at least two sides which extend in a direction substantially parallel to the direction each loop extends.

21. The airbag assembly of claim 20, wherein each internal tether is attached to a side of at least one loop on the first side of the inflatable cushion, on the outside of the loop, and each internal tether is attached to a side of at least one loop on the second side of the inflatable cushion, on the outside of the loop.

22. The airbag assembly of claim 19, wherein each loop in the fabric of the inflatable cushion extends in a direction toward the outside of the inflatable cushion, such that each loop has at least two sides which extend in a direction substantially parallel to the direction each loop extends.

23. The airbag assembly of claim 22, wherein each internal tether is attached to the sides of at least one loop on the first side of the inflatable cushion, on the inside of the loop, and each internal tether is attached to the sides of at least one loop on the second side of the inflatable cushion, on the inside of the loop.

24. The airbag assembly of claim 21, further comprising two loops in the first side of the inflatable cushion, two loops in the second side of the inflatable cushion, and two internal tethers, such that each internal tether is attached to and interconnects a loop on the first side and a loop on the second side of the inflatable cushion.

25. The airbag assembly of claim 21, further comprising three loops in the first side of the inflatable cushion, three loops in the second side of the inflatable cushion, and three internal tethers, such that each internal tether is attached to and interconnects a loop on the first side and a loop on the second side of the inflatable cushion.

26. The airbag assembly of claim 21, wherein each internal tether has a width shorter than a distance that the first side of the inflatable cushion can be separated from the second side.

27. The airbag assembly of claim 26, wherein the inflatable cushion is formed from one continuous sheet of fabric material.

28. The airbag assembly of claim 27, further comprising an inflator for inflating the inflatable cushion.

29. The airbag assembly of claim 28, wherein the inflator inflates the inflatable cushion to an internal pressure between about 6 pounds per square inch and about 14 pounds per square inch.

30. The airbag assembly of claim 28, wherein the inflator inflates the inflatable cushion to an internal pressure between about 10 pounds per square inch and about 14 pounds per square inch.

31. A knee airbag assembly, comprising:
an inflatable cushion formed from one continuous sheet of fabric material, the inflatable cushion having a first side and a second side, the first and second sides being opposite each other;
a plurality of loops formed in the fabric of the inflatable cushion, such that about one-half of the plurality of loops are formed on the first side and about one-half of the plurality of loops are formed opposite on the second side, where each loop extends in a direction toward the inside of the inflatable cushion;
a plurality of tethers located on an internal side of the inflatable cushion, each internal tether attached to a side of a loop on the first side of the inflatable cushion, on the outside of the loop, and each internal tether is attached to a side of a loop on the second side of the inflatable cushion, on the outside of the loop;
a tether located on an external side of the inflatable cushion, the external tether being attached to the fabric of the second side of the inflatable cushion; and
an inflator that inflates the inflatable cushion to an internal pressure between about 10 pounds per square inch and about 14 pounds per square inch.

32. The knee airbag assembly of claim 31, wherein the plurality of loops comprises four loops, and the plurality of internal tethers comprises two internal tethers.

33. The knee airbag assembly of claim 32, wherein the plurality of loops comprises six loops, and the plurality of internal tethers comprises three internal tethers.

34. A method of constructing a fabric knee airbag that can withstand high internal pressure, comprising:
obtaining a continuous fabric sheet;
forming two or more loops in the sheet;
folding the sheet in half, such that at least one loop is located on an opposing side of the sheet from another loop;
attaching a first tether inside the airbag to at least one loop and attaching the first tether to at least one loop on the opposing side of the sheet, such that the first tether interconnects a pair of opposing loops; and
sealing a perimeter of the folded fabric sheet so that the airbag can retain inflation gases.

35. The method of claim 34, further comprising attaching a second tether to an external side of the airbag, such that the airbag fabric underneath the second tether is loose when the second tether is pulled tight.

36. The method of claim 34, wherein the loops extend in a direction toward the inside of the inflatable cushion and the first tether is attached to a side of each loop of the pair of opposing loops, on the outside of each loop.

37. The method of claim 34, wherein the loops extend in a direction toward the outside of the inflatable cushion, and the first tether is attached to both sides of each loop of the pair of opposing loops, on the inside of each loop.
